(19) United States
(12) Patent Application Publication
(10) Pub. No.: US 2024/0320464 A1
(43) Pub. Date: Sep. 26, 2024

(54) METHOD AND DEVICE FOR DETERMINING SATURATION RATIO-BASED QUANTIZATION RANGE FOR QUANTIZATION OF NEURAL NETWORK

(71) Applicant: SAPEON KOREA INC., Seongnam-si, Gyeonggi-do (KR)

(72) Inventor: Yong seok CHOI, Seoul (KR)

(21) Appl. No.: 18/580,199

(22) PCT Filed: Jul. 22, 2022
(86) PCT No.: PCT/KR2022/010810

§ 371 Date: Jan. 18, 2024

(30) Foreign Application Priority Data
Jul. 22, 2021 (KR) 10-2021-0096632

(51) Int. Cl. G06N 3/04

(52) U.S. Cl. CPC G06N 3/04

(57) ABSTRACT

A method and a device for determining a quantization range based on a saturation ratio for quantization of an artificial neural network are disclosed.

According to one aspect of the present invention, there is provided a computer-implemented method and a device for determining a quantization range for tensors of an artificial neural network, comprising observing a saturation ratio at a current iteration from the tensors of the artificial neural network and the quantization range; and adjusting the quantization range so that the observed saturation ratio follows a predetermined target saturation ratio.

### TECHNICAL FIELD

Embodiments of the present disclosure relate to a method and device for determining a quantization range for quantization of a neural network, and more specifically, to a method and device for determining a quantization range based on a saturation ratio which is a ratio of tensors outside the quantization range.

### BACKGROUND ART

The content described below simply provides background information related to the present disclosure and does not constitute prior art.

An artificial neural network (ANN) may refer to a computing system based on the biological neural network constituting the brain of an animal. An artificial neural network (ANN) has a structure in which nodes representing artificial neurons are connected through synapses. Nodes can process signals received through synapses and transmit the processed signals to other nodes. Signals from each node are transmitted to other nodes through weights associated with nodes and weights associated with synapse. When a signal processed at one node is transmitted to the next node, the influence thereof varies depending on the weight.

Here, a weight associated with a node is referred to as a bias, and the output of the node is referred to as an activation. A weight, a bias, and an activation may be referred to as a tensor. That is, a tensor is a concept that includes at least one of a weight, a bias, and an activation.

Meanwhile, artificial neural networks can be used for various machine learning operations such as image classification and object recognition. The accuracy of an artificial neural network can be improved by extending one or more dimensions such as a network depth, a network width, and an image resolution. However, this leads to problems that computational complexity and memory requirements increase, and energy consumption and execution time increase.

To reduce computational complexity, quantization of artificial neural networks is being studied. Here, quantization means mapping tensor values from a dimension with a wide data representation range to a dimension with a narrow data representation range. In other words, quantization means that a processor that processes neural network operations maps high-precision tensors to low-precision values. In artificial neural networks, quantization can be applied to tensors including activations, weights, and biases of a layer.

Quantization can reduce the computational complexity of a neural network by converting full-precision weights and activations to low-precision representations. For example, 32-bit floating-point numbers FP32 commonly used during training of artificial neural networks are converted into 8-bit integers INT8 which are discrete values after training is completed. As a result, the computational complexity required for neural network inference is reduced.

Quantization can be applied to all tensors with high precision, but is generally applied to tensors that fall within a specific range. In other words, in order to quantize tensors, a quantization range needs to be determined first according to the values of tensors with high precision. Here, determining a quantization range is referred to as calibration. Hereinafter, a device that determines a quantization range is referred to as a range determination device or a calibration device.

Once the quantization range is determined, tensors included in the quantization range among high-precision tensors are mapped to low-precision values. On the other hand, tensors outside the quantization range are mapped to either the maximum or minimum of the low-precision representation range. The state in which tensors outside the quantization range are mapped to the maximum or minimum of the low-precision expression range is called a saturation state.

FIG. 1a and FIG. 1b are diagrams illustrating quantization and saturation of an artificial neural network.

FIG. 1a and FIG. 1b illustrate a process of quantizing tensors represented in FP32 such that they are represented in INT8.

To reduce the computational complexity of neural network inference, tensors represented with high precision in the FP32 system can be quantized into the INT8 system with low precision through quantization.

For quantization of tensors, a range determination device for determining a quantization range determines the quantization range in the FP32 representation system. That is, the range determination device determines a threshold T of the quantization range for clipping tensors.

Here, depending on the quantization range, distortion or resolution reduction occurs due to saturation of tensors. Distortion and resolution reduction due to saturation of tensors are in a trade-off relationship.

As shown in FIG. 1a, when the range determination device sets the quantization range to be wide, all tensors represented in FP32 are included in the quantization range. Tensors included in the quantization range are unlikely to be saturated. That is, they have a low probability of being mapped to the maximum or minimum of the INT8 representation system. This means that there is less distortion due to saturation of tensors.

However, when a wide quantization range is set, the probability of tensors with different values in the FP32 system having the same value in the INT8 system increases. When tensors with high precision are mapped to the same value due to quantization, the resolution of the tensors decreases. The lower the resolution of the tensors, the lower the performance of the neural network.

Therefore, when a wide quantization range is set, distortion due to saturation of tensors is reduced, but resolution of the tensors is also reduced.

On the other hand, when the range determination device sets a narrow quantization range as shown in FIG. 1b, some of tensors represented in FP32 are included in the quantization range and others are outside the quantization range. Due to the narrow quantization range, tensors that have different values in the FP32 system are likely to have different values in the INT8 system. This means that reduction in resolution of tensors is limited.

However, when a narrow quantization range is set, tensors that are not included within the quantization range −T to T may be mapped to either the maximum or minimum of the INT8 representation system. For example, when the maximum and minimum of the INT8 representation system are 127 and −127, respectively, tensors outside the quantization range are mapped to 127 or −127. Otherwise, the tensors outside the quantization range may be deleted or ignored without being quantized. That is, distortion occurs due to saturation of tensors. The greater the distortion due to saturation of tensors, the lower the performance of the neural network.

Therefore, when a narrow quantization range is set, there is a problem that the resolution of quantized tensors decreases less, whereas distortion due to saturation increases.

To control the trade-off between distortion and resolution reduction due to saturation of tensors, the range determination device needs to determine an appropriate quantization range. That is, the quantization range needs to be determined to include data representing task characteristics of an artificial neural network.

FIG. 2 is a diagram illustrating a conventional process of determining a quantization range.

Referring to FIG. 2, activations are calculated as tensors in an artificial neural network in process S200. Activations can be calculated through an activation function of nodes included in the neural network.

The calculated activations are classified or a histogram is generated from the activations in process S210.

In process S220, the horizontal axis of the histogram represents the activation value, and the vertical axis represents the number of activations. In general, the distribution of activations has a form in which the number of activations decreases as activation values increase. In process S220 and process S230, the histogram shows a case in which activations are represented only as positive numbers. This is merely one embodiment, and activations may include all of positive numbers, 0, and negative numbers, as shown in FIG. 1a and FIG. 1b.

In process S230, a clipping threshold for the quantization range is determined. In process S230, 5% of the activations greater than the clipping threshold can be mapped to an INT8 system value corresponding to the maximum of the quantization range in the FP32 system. As another example, if the activations include positive numbers, zero, and negative numbers, the clipping threshold may have an upper limit and a lower limit. Activations greater than the upper limit of the clipping threshold may be mapped to the maximum of the INT8 system, and activations less than the lower limit of the clipping threshold may be mapped to the minimum of the INT8 system.

A conventional method of determining a quantization range analyzes the distribution of activation through histogram generation and determines a quantization range based on the distribution of activation.

Representative conventional methods for determining a quantization range include an entropy-based determination method, a preset ratio-based determination method, and a maximum-based determination method. The entropy-based determination method is a method of determining a quantization range such that the Kullback-Leibler divergence (KLD) according to distributions before and after quantization is minimized. The preset ratio-based determination method is a method of determining a quantization range such that the quantization range includes tensors of a preset ratio. The maximum-based determination method is a method of determines the maximum of activation as the maximum of the quantization range.

However, conventional quantization range determination methods have the problem of high computational complexity due to histogram generation, classification, and minimum/maximum calculation.

Since conventional quantization range determination methods have high computational complexity, they are performed by a PC or a server with excellent computational performance before distribution of a trained neural network. This is because, due to computational complexity, it is difficult to adjust the quantization range in general-purpose devices or mobile devices with low computational performance. In other words, low-performance devices with low computational performance have no choice but to perform inference using a fixed quantization range. This acts as a factor that reduces the performance of the neural network. There is a problem that the quantization range is fixed in the inference stage of an artificial neural network.

Therefore, research on methods of adjusting a quantization range even at the interference stage by decreasing the computational complexity for determining the quantization range is required.

### DISCLOSURE

### Technical Problem

An object of embodiments of the present disclosure is to provide a quantization range determination method and device for reducing computational complexity while minimizing performance degradation of an artificial neural network by observing the saturation ratio of tensors without generating a histogram and determining a quantization range such that that the observed saturation ratio follows a target saturation ratio.

An object of other embodiments of the present disclosure is to provide a quantization range determination method and device which are applicable not only in a training stage of an artificial neural network but also in an inference stage, that is, even after distribution of a trained neural network through low computational complexity.

### Technical Solution

According to one aspect of the present disclosure, a computer-implemented method of determining a quantization range for tensors of an artificial neural network is provided, the method comprising observing a saturation ratio at a current iteration from the tensors and a quantization range of the artificial neural network; and adjusting the quantization range such that the observed saturation ratio follows a preset target saturation ratio.

According to other aspect of the present disclosure, a device is provided that comprises a memory; and a processor configured to execute computer-executable procedures stored in the memory, wherein the computer-executable procedures comprise an observer configured to observe a saturation ratio at a current iteration from tensors and a quantization range of an artificial neural network; and a controller configured to adjust the quantization range such that the observed saturation ratio follows a preset target saturation ratio.

### Advantageous Effect

As described above, according to an embodiment of the present invention, the saturation ratio of tensors is observed without generating a histogram and the quantization range is determined so that the observed saturation ratio follows the target saturation ratio, thereby minimizing performance degradation of the artificial neural network and reducing calculation complexity.

According to another embodiment of the present invention, due to low computational complexity, the quantization range can be adjusted not only during the training stage of the artificial neural network, but also after the inference stage, that is, distribution of the trained neural network.

According to another embodiment of the present invention, the quantization range can be adjusted in the inference stage of the artificial neural network, so the accuracy of the neural network can be improved through adaptive calibration for user data.

According to another embodiment of the present invention, since the quantization range can be adjusted in the inference stage of the artificial neural network, convenience and data security can be achieved by omitting calibration before deployment of the artificial neural network.

### BRIEF DESCRIPTION OF THE DRAWINGS

FIG. 1a and FIG. 1b are diagrams illustrating quantization and saturation of an artificial neural network.

FIG. 2 is a diagram illustrating a conventional process of determining a quantization range.

FIG. 3 is a diagram illustrating a method of determining a quantization range according to an embodiment of the present disclosure.

FIG. 4 is a diagram illustrating a process of adjusting a quantization range according to an embodiment of the present disclosure.

FIG. 5 is a flowchart illustrating a process of adjusting a quantization range according to an embodiment of the present disclosure.

FIG. 6 is a configuration diagram of a device for determining a quantization range according to an embodiment of the present disclosure.

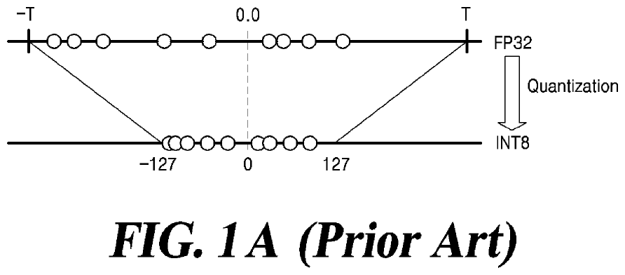

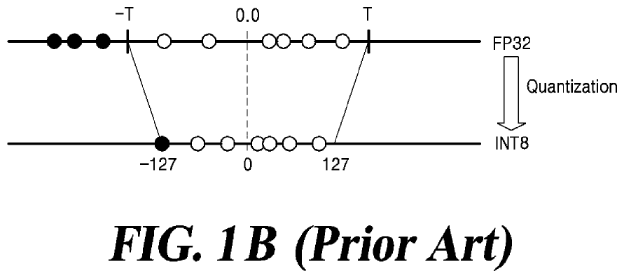

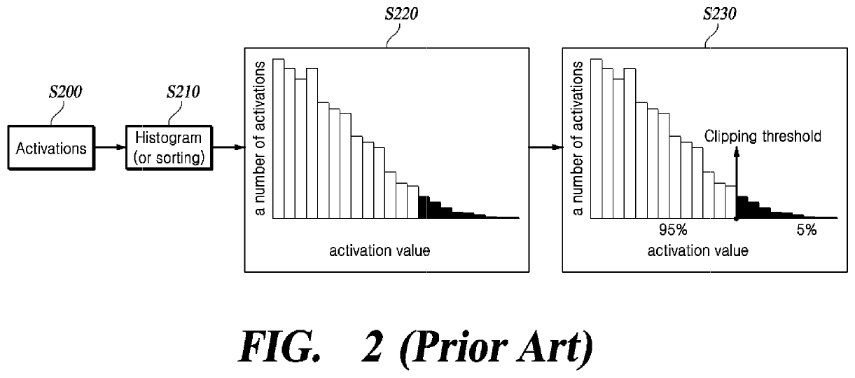

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

In the present disclosure, a tensor includes at least one of a weight, a bias, and an activation. However, for convenience of description below, a tensor is described as an activation. When a tensor means an activation, the tensor may be referred to as feature data and may be the output of at least one layer in an artificial neural network. In addition, a method of determining a quantization range according to an embodiment of the present disclosure can be applied to both the training stage and the inference stage of an artificial neural network, and thus a tensor may be derived by a layer from either training data in the training stage of the artificial neural network or user data in the inference stage. In particular, the quantization range can be adjusted according input data of a user by applying the method of determining a quantization range according to an embodiment of the present disclosure to the inference stage. Accordingly, the accuracy of the neural network according to the input data of the user can be improved.

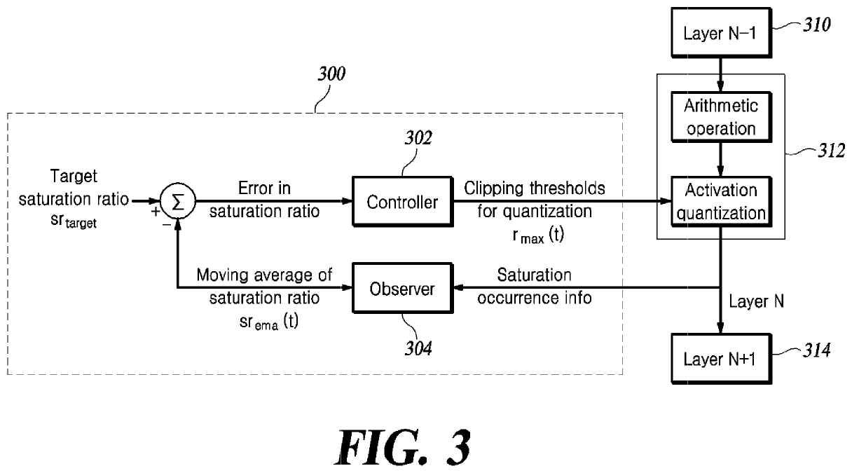

FIG. 3 is a diagram illustrating a method of determining a quantization range according to an embodiment of the present disclosure.

FIG. 3 shows a quantization range determination device 300 (hereinafter referred to as a range determination device), a controller 302, an observer 304, a layer N−1 310, a layer N 312, and a layer N+1 314. The range determination device 300 includes the controller 302 and the observer 304.

An artificial neural network (ANN) or a deep learning architecture may have a structure including at least one layer. In FIG. 3, the layer N−1 310, layer N 312, and layer N+1 314 may constitute an artificial neural network. The artificial neural network may have any neural network architecture to which the method of determining a quantization range can be applied, such as a convolutional neural network and a recurrent neural network.

An artificial neural network may be composed of an input layer, a hidden layer, and an output layer, and the output of each layer may be the input of the subsequent layer. Each of the layers includes a plurality of nodes and is trained using a plurality of pieces of training data. Here, training data refers to input data processed by an artificial neural network, such as audio data and video data.

In FIG. 3, an activation N−1, which is a signal processing result of the layer N−1 310, is transmitted from the layer N−1 310 to the layer N 312, and arithmetic operations are performed on the activation N−1. The arithmetic operations refer to calculating values input to nodes according to weights and biases, a convolution operation, etc. An activation of the layer N 312 is calculated from the results of the arithmetic operation of the layer N 312 through an activation function. Thereafter, the activation is quantized, and the quantized activation is transmitted to the layer N+1 314.

Neural network operations, such as the above-described arithmetic operations, activation function operations, and activation quantization, are performed by a device that processes neural network operations (hereinafter referred to as a processing device). That is, the processing device is a device that performs learning or inference by processing operations of the layer N−1 310, the layer N 312, and the layer N+1 314 included in the neural network.

The range determination device 300 according to an embodiment of the present disclosure observes a saturation ratio at the current iteration from the activations and quantization range of the artificial neural network and adjusts the quantization range such that the observed saturation ratio follows a preset target saturation ratio. The quantization range of initial iteration may be a preset range, and the quantization range may be adjusted at each iteration. The range determination device 300 can individually adjust the quantization range for each layer. The unit of repetition may refer to a unit in which quantization is performed.

The observer 304 observes a saturation ratio of activations from the activations of the layer N 312 and the quantization range at the current iteration.

Specifically, the observer 304 counts the total number of activations of the layer N 312 and counts the number of activations outside the quantization range. The observer 304 calculates the ratio of the number of activations outside the quantization range to the total number of activations as the saturation ratio.

The observer 304 can calculate the saturation ratio by counting the total number of activations and the number of activations outside the quantization range rather than generating a histogram of activations. The observer 304 can calculate the saturation ratio by determining whether each activation is outside the quantization range based on the threshold of the quantization range without analyzing the distribution of activations. The observer 304 can omit complex operations including histogram generation, thereby reducing the computational complexity of calibration.

Meanwhile, the observer 304 calculates a moving average of the saturation ratio at the current iteration from activation saturation occurrence information. Here, the moving average may mean an exponential moving average (EMA). However, the exponential moving average is merely one embodiment, and the moving average may include various moving averages such as a simple moving average and a weighted moving average.

To calculate the moving average of the saturation ratio at the current iteration, the observer 304 calculates a past moving average from saturation ratios observed at previous iterations. The observer 304 calculates the current moving average based on the observed saturation ratio at the current iteration and the past moving average. The current moving average becomes a representative value of the saturation ratio of activations in the layer N 312. The number of previous iterations used to calculate the past moving average may be set to an arbitrary value.

According to one embodiment of the present disclosure, the observer 304 can calculate the current moving average through a weighted sum of the observed saturation ratio at the current iteration and the past moving average. Specifically, the observer 304 can obtain the current moving average of the saturation ratio through Formula 1.

$$s {r}_{ema} ( t ) = α \cdot sr ( t ) + ( 1 - α ) \cdot {sr}_{ema} ( t - 1 ) \qquad [ Formula 1 ]$$

In Formula 1, srₑₘₐ(t) is the current moving average of the saturation ratio, a is the smoothing factor, sr(t) is the observed saturation ratio, and srₑₘₐ(t−1) is the past moving average. The smoothing factor has a value between 0 and 1.

According to an embodiment of the present disclosure, the observer 304 can adjust the value of the smoothing factor. As the number of times of adjusting the quantization range increases, a smaller weight can be set for the past moving average. Alternatively, the range determination device may set the weight for the past moving average to be smaller as time elapses. Accordingly, the observer 304 can rapidly adapt the artificial neural network to user data by adjusting the smoothing factor in the inference stage.

For example, observer 304 may gradually increase or gradually decrease the smoothing factor. Additionally, the observer 304 may set the smoothing factor to be large immediately after distribution of the artificial neural network and decrease the smoothing factor according to the number of range adjustments or with time. On the other hand, the observer 304 may set the smoothing factor to be small immediately after distribution of the artificial neural network and increase the smoothing factor according to the number of range adjustments or with time. In addition, the observer 304 may increase or decrease the smoothing factor immediately after distribution of the artificial neural network and then fix the smoothing factor.

According to an embodiment of the present disclosure, the observer 304 may gradually set the smoothing coefficient to be larger depending on the number of range adjustments or with time. Specifically, immediately after distribution of a trained neural network, there is a high probability that there will be a large difference between an observed saturation ratio and a target saturation ratio. Here, since the controller 302 determines the quantization range based on the difference between the observed saturation ratio and the target saturation ratio, the observer 304 may set the smoothing factor to be small to reduce fluctuation. The observer 304 may adjust the smoothing factor over time.

According to another embodiment of the present disclosure, the observer 304 may adjust the smoothing factor according to task characteristics of the artificial neural network. If it is advantageous for the task performance of the artificial neural network to determine the quantization range by considering the saturation ratio derived from past input data, the observer 304 may set the smoothing factor to be small. On the other hand, if it is advantageous for the task performance of the artificial neural network to determine the quantization range by considering the saturation ratio derived from recently input data more than the saturation ratio derived from past input data, the observer 304 adjusts the smoothing factor to be large.

According to another embodiment of the present disclosure, the range determination device 300 may stop adjustment of the quantization range when the smoothing factor becomes 0. When the distribution of activations does not vary significantly, determining the quantization range may waste resources. Specifically, the observer 304 may set the smoothing factor to be smaller as time elapses and may set the smoothing factor to 0 after a preset time. The range determination device 300 may stop adjustment of the quantization range when the smoothing factor becomes 0.

The controller 302 adjusts the quantization range such that the saturation ratio observed by the observer 304 follows a preset target saturation ratio. Adjusting the quantization range means determining the clipping threshold. The target saturation ratio can be preset or input.

Specifically, the controller 302 adjusts the quantization range based on the difference between the target saturation ratio and the current moving average of the saturation ratio for activations in the layer N 312. The controller 302 calculates the amount of change in the quantization range based on the difference between the current moving average of the saturation ratio and the target saturation ratio and adjusts the quantization range according to the amount of change in the quantization range.

According to an embodiment of the present disclosure, the controller 302 may determine the scales of the minimum and maximum of the quantization range to be different. This is called affine quantization.

The controller 302 may determine the scales of the minimum and maximum of the quantization range to be the same. That is, the controller 302 can symmetrically determine the quantization range. This is called scale signed quantization.

The controller 302 may determine the minimum and the maximum of the quantization range to be values equal to or greater than 0. For example, the controller 302 may determine the minimum of the quantization range to be 0 and determine the maximum to be greater than 0. This is called scale unsigned quantization.

According to an embodiment of the present disclosure, the controller 302 may set the initial value of the quantization range based on batch normalization parameters of the artificial neural network. For example, in a distribution having a batch normalization bias as a mean and having a scale as a standard deviation, a clipping boundary that satisfies a specific sigma can be determined as the initial value of the quantization range. The initial value of the quantization range is applied to tensors output from one layer. That is, the initial value of the quantization range is applied to the tensors at the initial iteration.

Meanwhile, the controller 302 can determine the quantization range by using feedback control based on the current saturation ratio and the target saturation ratio of activations. Here, the feedback control includes at least one of proportional integral derivative (PID) control, PI control, ID control, PD control, proportional control, integral control, and differential control.

PID control is a control loop feedback mechanism widely used in control systems. PID control is a combination of proportional control, integral control, and differential control. PID control has an architecture in which a current value of a control target is obtained, an error is calculated by comparing the obtained current value with a set point, and a control value required for control is calculated using the error value. The control value is calculated by a PID control function composed of a proportional term, an integral term, and a differential term. The proportional term is proportional to the error value, the integral term is proportional to the integral of the error value, and the differential term is proportional to the derivative of the error value. The respective terms may include a proportional gain parameter, which is the gain of the proportional term, an integral gain parameter, which is the gain of the integral term, and a differential gain parameter, which is the gain of the differential term, as PID parameters.

According to an embodiment of the present disclosure, the controller 302 sets the target saturation ratio as a set point and sets the current moving average of the saturation ratio as a measured variable. The controller 302 sets the amount of change in the quantization range as an output. By applying PID control to the settings, the controller 302 can obtain the amount of change in the quantization range that causes the current saturation ratio to follow the target saturation ratio. The controller 302 determines the quantization range according to the amount of change in the quantization range.

Meanwhile, the method of determining a quantization range can be implemented in an arithmetic operation device. Here, the arithmetic operation device may be a device with low arithmetic operation performance or a low-performance device such as a mobile device. For example, an arithmetic operation device may be a device that receives a trained neural network model and performs inference using the neural network model and collected user data.

In a case where a conventional method of determining a quantization range is used, it is difficult for low-performance devices to adjust the quantization range due to computational complexity. Specifically, although low-performance devices can perform inference using a trained neural network, it is difficult for the low-performance devices to perform histogram generation, classification, maximum calculation, and minimum calculation for quantization adjustment. Therefore, it may be impossible for low-performance devices to perform inference while adjusting the quantization range.

Since low-performance devices cannot adjust the quantization range, low-performance devices have no choice but to receive information on the quantization range from a server when the server distributes a neural network thereto and perform inference based on the fixed quantization range. This deteriorates the performance and accuracy of the neural network.

However, in a case where the method of determining a quantization range according to an embodiment of the present disclosure is used, low-performance devices can also adjust the quantization range because the computational complexity is low. Low-performance devices can adjust the quantization range according to a target saturation ratio without performing complex operations such as histogram generation, classification, maximum calculation, and minimum calculation.

Furthermore, in a case where the method of determining a quantization range according to an embodiment of the present disclosure, low-performance devices can dynamically adjust the quantization range while performing inference using a trained neural network. This is called dynamic calibration.

Low-performance devices can improve the accuracy of neural networks by applying dynamic calibration to user data during the inference stage. Additionally, since the quantization range can be adjusted even in low-performance devices, the calibration process of the server that distributes artificial neural networks can be omitted. Since the server does not need to collect data for calibration, convenience and data security can be achieved.

The method of determining a quantization range according to an embodiment of the present disclosure may be implemented in a high-performance device such as a PC or a server. After training an artificial neural network, a high-performance device can determine the quantization range for the trained artificial neural network using the method of determining a quantization range according to an embodiment of the present disclosure. Meanwhile, a high-performance device can apply the method of determining a quantization range according to an embodiment of the present disclosure to the training stage.

The range determination device 300 according to an embodiment of the present disclosure may be implemented as a separate device from a processing device that processes neural network operations, or may be implemented as a single device.

According to an embodiment of the present disclosure, the range determination device 300 and the processing device may be implemented in one arithmetic operation device. That is, the arithmetic operation device may include the range determination device 300 and the processing device. In this case, the processing device may be a hardware accelerator. The arithmetic operation device may further include a compiler. The arithmetic operation device determines a quantization range using the range determination device 300 and performs neural network operations according to the quantization range using the hardware accelerator.

Specifically, the range determination device 300 determines the quantization range, and the compiler converts the quantization range into a value that can be used by the hardware accelerator. The compiler converts the quantization range into a scaling factor for each layer.

The hardware accelerator receives information on the quantization range from the range determination device 300 and quantizes activations according to the information on the quantization range. The information on the quantization range includes the quantization range or scaling factors. The range determination device 300 may obtain activations quantized by the hardware accelerator. The hardware accelerator receives scaling factors and quantizes activations according to the scaling factors.

The hardware accelerator may include a memory and a processor. The memory stores at least one instruction, and the processor executes the at least one instruction to perform quantization according to the quantization range. The hardware accelerator may quantize tensors of an artificial neural network based on the quantization range determined according to an embodiment of the present disclosure.

The range determination device 300 aggregates quantized activations. The range determination device 300 adjusts the quantization range based on the aggregated quantized activations. Specifically, the range determination device 300 observes a saturation ratio at the current iteration and adjusts the quantization range such that the observed saturation ratio follows a preset target saturation ratio.

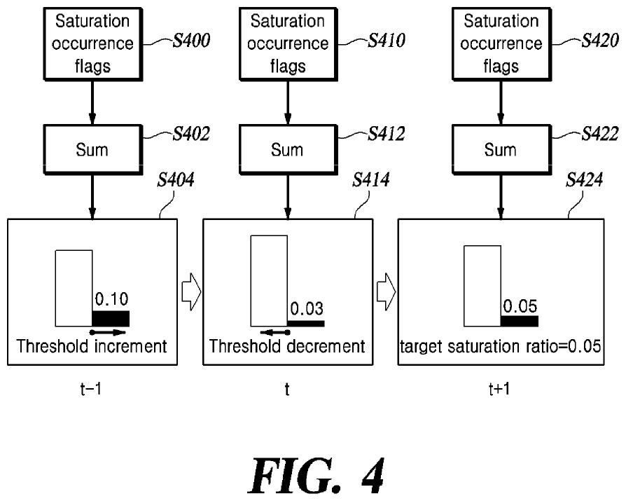

FIG. 4 is a diagram illustrating a process of adjusting a quantization range according to an embodiment of the present disclosure.

Referring to FIG. 4, the range determination device for determining a quantization range aims to determine a quantization range such that a saturation ratio for tensors of an artificial neural network becomes 0.05.

In process S400, the range determination device observes saturation occurrence flags from layers of the artificial neural network. Specifically, the range determination device checks the number of tensors from the output of the artificial neural network and checks the number of tensors outside the quantization range.

In process S402, the range determination device sums the number of tensors of the artificial neural network and sums the number of tensors outside the quantization range.

In process S404, the range determination device calculates the ratio of the number of tensors outside the quantization range to the total number of tensors as a saturation ratio. The saturation ratio observed at time t−1 is 0.10. There is a difference of 0.05 between the observed saturation ratio and the target saturation ratio.

Accordingly, the range determination device increases a clipping threshold based on the difference between the observed saturation ratio and the target saturation ratio. In other words, the range determination device widens the quantization range such that the saturation ratio of the tensors decreases.

In process S410 and process S412, the range determination device observes the saturation ratio at time t. The saturation ratio observed at time t is 0.03. There is a difference of 0.02 between the observed saturation ratio and the target saturation ratio.

Accordingly, the range determination device reduces the clipping threshold based on the difference between the observed saturation ratio and the target saturation ratio. In other words, the range determination device narrows the quantization range such that the saturation ratio of the tensors increases.

Thereafter, the range determination device may achieve the target saturation ratio through processes S420, S422, and S424.

The range determination device can gradually reduce the error between the target saturation ratio and the observed saturation ratio or the error between the target saturation ratio and the current moving average through feedback control. Additionally, the range determination device can maintain the saturation ratio at the target saturation ratio during quantization.

Furthermore, the range determination device can reduce computational complexity for determining the quantization range by counting saturation occurrence flags without generating a histogram or classifying tensors. This allows the quantization range to be adjusted even at the inference stage.

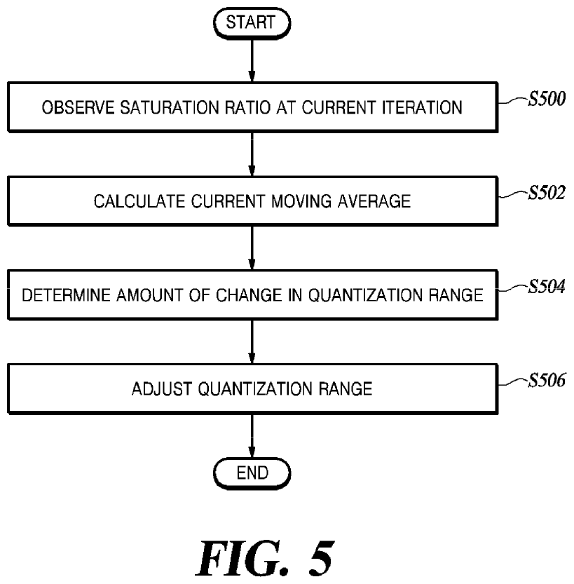

FIG. 5 is a flowchart illustrating a process of adjusting a quantization range according to an embodiment of the present disclosure.

Referring to FIG. 5, the range determination device that determines a quantization range for tensors of an artificial neural network observes a saturation ratio at the current iteration from the tensors and the quantization range of the artificial neural network (S500).

The range determination device may calculate the ratio of the number of tensors outside the quantization range to the number of tensors as the saturation ratio.

The range determination device calculates a past moving average from saturation ratios observed at previous iterations and calculates a current moving average based on the past moving average and the observed saturation ratio (S502).

According to an embodiment of the present disclosure, the range determination device can calculate the current moving average through a weighted sum of the past moving average and the observed saturation ratio. In this case, the range determination device can adjust the weight for the past moving average and the weight for the observed saturation ratio. Here, a weight refers to a smoothing factor.

The range determination device calculates the amount of change in the quantization range based on the difference between the current moving average and the target saturation ratio (S504). The range determination device calculates the amount of change in the quantization range such that the current moving average of the saturation ratio follows the target saturation ratio.

According to an embodiment of the present disclosure, the range determination device can calculate the amount of change in the quantization range using at least one of PID control, PI control, ID control, PD control, proportional control, integral control, and differential control.

The range determination device adjusts the quantization range according to the amount of change in the quantization range (S506).

According to an embodiment of the present disclosure, the controller 302 may determine the scales of the minimum and maximum of the quantization range to be different.

According to an embodiment of the present disclosure, the controller 302 may determine the scales of the minimum and the maximum of the quantization range to be the same. That is, the controller 302 can symmetrically determine the quantization range.

According to an embodiment of the present disclosure, the controller 302 may determine the minimum and the maximum of the quantization range to be values equal to or greater than 0. For example, the controller 302 may determine the minimum of the quantization range to be 0 and determine the maximum to be greater than 0.

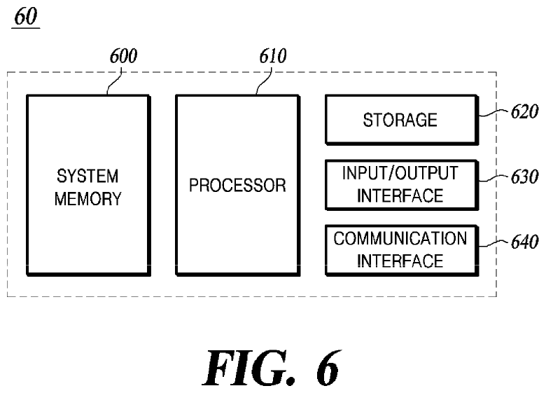

FIG. 6 is a configuration diagram of a device for determining a quantization range according to an embodiment of the present disclosure.

Referring to FIG. 6, the range determination device 60 may include some or all of a system memory 600, a processor 610, a storage 620, an input/output interface 630, and a communication interface 640.

The system memory 600 may store a program that causes the processor 610 to perform the range determination method according to an embodiment of the present disclosure. For example, the program may include a plurality of instructions executable by the processor 610, and a quantization range of an artificial neural network may be determined by the processor 610 executing the plurality of instructions.

The system memory 600 may include at least one of a volatile memory and a non-volatile memory. The volatile memory includes a static random access memory (SRAM), a dynamic random access memory (DRAM), or the like, and the non-volatile memory includes a flash memory or the like.

The processor 610 may include at least one core capable of executing at least one instruction. The processor 610 can execute instructions stored in the system memory 600 and can perform the method of determining a quantization range of an artificial neural network by executing the instructions.

The storage 620 maintains the stored data even if power supplied to the range determination device 60 is cut off. For example, the storage 620 may include a nonvolatile memory such as an electrically erasable programmable read-only memory (EEPROM), a flash memory, a phase change random access memory (PRAM), a resistance random access memory (RRAM), or a nano floating gate memory (NFGM) or may include a storage medium such as a magnetic tape, an optical disk, or a magnetic disk. In some embodiments, the storage 620 may be removable from range determination device 60.

According to an embodiment of the present disclosure, the storage 620 may store a program for determining a quantization range for tensors of an artificial neural network. The program stored in the storage 620 may be loaded into the system memory 600 before being executed by the processor 610. The storage 620 can store files written in a program language, and programs created from files by a compiler or the like can be loaded into the system memory 600.

The storage 620 may store data to be processed by the processor 610 and data that has been processed by the processor 610. For example, the storage 620 may store the amount of change in a quantization range to adjust the quantization range. Additionally, the storage 620 may store saturation ratios of previous iterations or past moving averages in order to calculate a moving average of a saturation ratio.

The input/output interface 630 may include an input device such as a keyboard or a mouse, and may include an output device such as a display device or a printer.

A user may trigger execution of a program by the processor 610 through the input/output interface 630. Additionally, the user may set a target saturation ratio through the input/output interface 630.

The communications interface 640 provides access to external networks. For example, the range determination device 60 may communicate with other devices through the communication interface 640.

Meanwhile, the range determination device 60 may be a stationary arithmetic operation device such as a desktop computer, a server, an AI accelerator, or the like as well as a portable arithmetic operation device such as a laptop computer, a smart phone, or the like.

The observer and the controller included in the range determination device 60 may be a procedure as a set of a plurality of instructions executed by the processor and may be stored in a memory accessible by the processor.

Although processes S500 to S506 are sequentially executed in FIG. 5, this is merely an exemplary description of the technical idea of an embodiment of the present disclosure. In other words, since the above processes can be modified and changed in various manners and applied by a person of ordinary skill in the technical field to which an embodiment of the present disclosure pertains in such a manner that the sequence shown in FIG. 5 is changed and the processes are executed or one or more of processes S500 to S506 are executed in parallel without departing from the essential characteristics of an embodiment of the present disclosure, FIG. 5 is not limited to a time series order.

Meanwhile, the processes shown in FIG. 5 can be implemented as computer-readable codes on a computer-readable recording medium. Computer-readable recording media include all types of recording devices that store data that can be read by a computer system. That is, such computer-readable recording media include non-transitory media such as a ROM, a RAM, a CD-ROM, a magnetic tape, a floppy disk, and optical data storage devices. Additionally, computer-readable recording media can be distributed across networked computer systems such that computer-readable code can be stored and executed in a distributed manner.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

### CROSS-REFERENCE TO RELATED APPLICATION

This application claims priority from Korean Patent Application No. 10-2021-0096632 filed on Jul. 22, 2021, the disclosures of which are incorporated by reference herein in their entireties.

(REFERENCE NUMERALS

| | |
|---|---|
| 300: range determination device | 302: controller |
| 304: observer) | |

1-15. (canceled)

16. A computer-implemented method of determining a quantization range for tensors of an artificial neural network, the method comprising:
observing a saturation ratio at a current iteration from the tensors and a quantization range of the artificial neural network; and
adjusting the quantization range such that the observed saturation ratio follows a preset target saturation ratio.

17. The method of claim 16, wherein the observing of the saturation ratio comprises calculating the ratio of the number of tensors outside the quantization range to the number of tensors.

18. The method of claim 16, wherein the adjusting of the quantization range comprises:
calculating a current moving average based on the observed saturation ratio and a past moving average calculated from saturation ratios observed at previous iterations; and
adjusting the quantization range based on a difference between the current moving average and the target saturation ratio.

19. The method of claim 18, wherein the calculating of the current moving average comprises calculating the current moving average through a weighted sum of the past moving average and the observed saturation ratio.

20. The method of claim 19, further comprising adjusting a weight of the past moving average and a weight of the observed saturation ratio.

21. The method of claim 18, wherein the adjusting of the quantization range comprises:
calculating an amount of change in the quantization range based on the difference between the current moving average and the target saturation ratio; and
adjusting the quantization range according to the amount of change in the quantization range.

22. The method of claim 16, further comprising setting an initial value of the quantization range based on batch normalization parameters of the artificial neural network.

23. The method of claim 16, wherein the tensors are derived from either training data in a training stage of the artificial neural network or user data in an inference stage.

24. A device comprising:
a memory; and
a processor configured to execute computer-executable procedures stored in the memory,
wherein the computer-executable procedures comprise:
an observer configured to observe a saturation ratio at a current iteration from tensors and a quantization range of an artificial neural network; and
a controller configured to adjust the quantization range such that the observed saturation ratio follows a preset target saturation ratio.

25. A computer-readable recording medium recording a computer program for executing the method of claim 16.

26. A computer-implemented method comprising:
receiving information on a quantization range from the outside; and
quantizing tensors of an artificial neural network based on the information on the quantization range,
wherein the quantization range is adjusted such that a observed saturation ratio from the quantized tensors of the artificial neural network at a current iteration follows a preset target saturation ratio.

27. The computer-implemented method of claim 26, wherein the observed saturation ratio is the ratio of the number of tensors outside the quantization range to the number of quantized tensors.

28. The computer-implemented method of claim 26, wherein the quantization range is adjusted based on a difference between a current moving average and the target saturation ratio at the current iteration,
wherein the current moving average is calculated based on and the observed saturation ratio and a past moving average calculated from saturation ratios observed at previous iterations.

29. A processing device comprising:
a memory in which at least one instruction is stored; and
at least one processor,
wherein the at least one processor is configured to, by executing the at least one instruction:
receive information on a quantization range from the outside; and
quantize tensors of an artificial neural network based on the information on the quantization range,
wherein the quantization range is adjusted such that a observed saturation ratio from the quantized tensors of the artificial neural network at a current iteration follows a preset target saturation ratio.

30. An arithmetic operation device comprising:
a range determination unit configured to observe a saturation ratio at a current iteration based on quantized tensors of an artificial neural network and to determine a quantization range such that the observed saturation ratio follows a preset target saturation ratio; and
a quantization unit configured to quantize the tensors of the artificial neural network based on the quantization range.
